(19) United States
(12) Patent Application Publication
(10) Pub. No.: US 2014/0019546 A1
(43) Pub. Date: Jan. 16, 2014

(54) METHOD AND SYSTEM FOR CREATING A USER PROFILE TO PROVIDE PERSONALIZED RESULTS

(71) Applicant: TELIBRAHMA CONVERGENT COMMUNICATIONS PVT. LTD., Bangalore (IN)

(72) Inventor: SURESH NARASIMHA, BANGALORE (IN)

(21) Appl. No.: 13/939,397

(22) Filed: Jul. 11, 2013

(30) Foreign Application Priority Data
Jul. 13, 2012 (IN) 2347/CHE/2012

(51) Int. Cl. H04L 29/08

(52) U.S. Cl. CPC H04L 67/306
USPC 709/204

(57) ABSTRACT

The various embodiments herein provide a method and system for providing personalization services to a user by creating a user profile from a user selected multimedia data. The method comprises capturing a multimedia data through a user mobile device, initializing a client application pre-installed in the device, uploading the captured multimedia data to a central server through the client application, processing the multimedia data by a profiling module in the central server, extracting one or more user preferences from the multimedia data and creating a profile for the user based on the extracted user preferences. The profiling module extracts one or more keywords from the multimedia data inputted by the user to define the one or more personalization parameters.

### CROSS-REFERENCE TO RELATED APPLICATIONS

The present application claims priority of the Indian provisional application serial number 2347/CHE/2012 filed on 13 Jul. 2012, and that application is incorporated in its entirety at least by reference.

### BACKGROUND

1. Technical field

The embodiments herein generally relate to data integration and processing systems and methods and particularly relates to a method and system for processing multimedia data and recognizing the content. The embodiments herein more particularly relates to a method and system for creating personalized profiles for users based on user activities and providing services based on the user profile.

2. Description of the Related Art

In the modem Web, as the amount of information available causes information overloading, the demand for personalized approaches for information access increases. Personalized systems address the overload problem, by building, managing, and representing information customized for individual users. This customization may take the form of filtering out irrelevant information and/or identifying additional information of likely interest for the user.

The method of providing automatic, personalized information services to a computer user is well discussed in the art. Most personalization systems are based on some type of user profile, a data instance of a user model that is applied to adaptive interactive systems. The user profiles generally includes demographic information, e.g., name, age, country, education level, and so on, and also represents the Interests or preferences of either a group of users or a single person. Generally personalization of profiles focuses on individual users, for example, displaying news about specifically chosen topics or the market summary of specifically selected stocks, or a group of users for whom distinctive characteristics where identified, for example, displaying targeted advertising on e-commerce sites.

In order to create, an individual user profile, information is collected through direct user intervention, or through agents that monitor user activities, where the user device is transparently monitored for acquiring the user usage statistics. The method analyzes document, website, or any similar information viewed by the user and to provide personalized service to the user. Though the prior art discloses methods and systems to provide personalized specific information based on the tracked text and documents, the prior art does not disclose information relating to providing services based on multimedia data inputted by the user for personalization.

Another prior art method provides personalization of user data in a portable mobile device. The personalization is carried, out to create an interface in the mobile device. The personalization is done based on the multimedia inputs, say images provided by the user. The images are analyzed and a theme is created for the user mobile device. Though the prior art explains personalization of user selected image, hut do not explain the creation of unique user personalized profile and timely updating the profile based on the user provided input date.

Currently numerous multimedia contents are made accessible, depending upon copyright, policy and security decisions, over the internet in a cost, time and place-efficient fashion. With the steadily increasing amount of digital multimedia content, the user will get confused and overloaded by the vast amounts of multimedia content available. Also the people (i.e. the ultimate content users) are not interested in the entire set of available content and like to search and retrieve only specific portions of it, according to their personalized preferences and needs. Thus the need for multimedia personalization is now more evident.

In view of the foregoing, there is a need for a method and system for providing personalized service to a user based on the multimedia content captured by a user. Further, there is a need for a method and system to create a user profile based on multimedia data captured by a mobile device. Moreover there is a need for a method and system for providing personalized services to a user from the beginning of accessing or requesting a service from a preferred service provider.

The abovementioned shortcomings, disadvantages and problems are addressed herein and which will be understood by reading and studying the following specification.

### SUMMARY

The primary object of the embodiments herein is to provide a method and system for automatically creating a user profile from the multimedia data captured using a mobile device.

Another object of the embodiments herein is to provide a method and system for processing, recognizing and extracting the user preferences from the captured multimedia data.

Another object of the embodiments herein is to provide a method and system for delivering personalized services to the user based on the user preferences defined by the user profile.

Another object of the embodiments herein is to provide a method and system for delivering services from the beginning of accessing a preferred service provider.

Another object of the embodiment herein is to provide a method and system to create a relational graph for the user based on the recognized content of the multimedia data.

These and other objects and advantages of the present embodiments will become readily apparent from the following detailed description taken in conjunction with the accompanying drawings.

The various embodiments herein provide a method for creating user profile from a user selected multimedia data. The method comprises capturing a multimedia data through a user mobile device, initializing a client application pre-installed in the device, uploading the captured multimedia data to a central server through the client application, processing the multimedia data by a profiling module in the central server, extracting one or more user preferences from the multimedia data and creating a profile for the user based on the extracted user preferences. The profiling module extracts one or more keywords from the multimedia data inputted by the user to define the one or more personalization parameters.

According to an embodiment herein, the method for creating user profile from a user selected multimedia data further comprises registering one or more service providers with the central server, accessing the profile of the user by the service providers, personalizing information based on the user preferences through a personalization engine in the central server and delivering personalized information to the user.

According to an embodiment herein, the multimedia data input is one of a text, a still image, an audio, a video, an animation and interactivity content forms.

According to an embodiment herein, the method for creating user profile from a user selected multimedia data further comprises leveraging the multimedia input provided by the user to build the user profile by the personalization engine.

According to an embodiment herein, the personalization parameters comprise at least one of user preferences, behavior patterns, transactions and subjects.

According to an embodiment herein, the method for creating user profile from a user selected multimedia data further comprises accessing at least one service provider by the user, providing login credentials of the personalization engine, transmitting the user credentials to the personalization engine by the service provider, retrieving the user profile defined in the profiling module and providing personalized information to the user based on the user preferences stored in the personalization engine.

Embodiments herein further provide a system for creating a user profile from a user selected multimedia data. The system comprises a mobile device for capturing a multimedia data, a client application pre-installed in the mobile device for capturing and uploading the captured data to a central server and a profiling module provided in the central server. The profiling module is adapted for processing the multimedia data, extracting one or more user preferences from the multimedia data and creating a profile for the user based on the extracted user preferences.

According to an embodiment herein, the system further comprises a personalization engine provided in the central server for storing the uploaded multimedia data and a plurality of service providers registered with the central server for providing the personalization information to one or more users.

According to an embodiment herein, the profiling module comprises one or more algorithms or software modules for decoding, analyzing, recognizing and generating one or more keywords associated with the input multimedia data to define the personalization parameters.

According to an embodiment herein, the client application connects to the central server through a communication network and provides a set of keywords generated to a central server.

According to an embodiment herein, the communication network is any of a Bluetooth, Wi-Fi, WLAN or the like compatible with the mobile device.

According to an embodiment herein, the plurality of service providers is any one of a mobile service provider, a secure enterprise service provider, a web based service provider and a consumer service provider.

These and other aspects of the embodiments herein will be better appreciated and understood when considered in conjunction with the following description and the accompanying drawings. It should be understood, however, that the following descriptions, while indicating preferred embodiments and numerous specific details thereof are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred, embodiment and the accompanying drawings in which:

FIG. 1 is a block diagram illustrating a system for automatically creating a user profile from a user selected multimedia data, according to an embodiment of the present disclosure.

FIG. 2 is a flow diagram illustrating a method for creating a user profile based on a user selected multimedia data, according to an embodiment of the present disclosure.

FIG. 3 is a flow diagram illustrating a method for providing personalized services to a user based on user preferences, according to an embodiment of the present disclosure.

Although the specific features of the present embodiments are shown in some drawings and not in others. This is done for convenience only as each feature may be combined with any or all of the other features in accordance with the present embodiments.

### DETAILED DESCRIPTION OF THE DRAWINGS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for creating user profile from a user selected multimedia data. The method comprises of capturing a multimedia data through a user mobile device, initializing a client application pre-installed in the device, uploading the captured multimedia data to a central server through the client application, processing the multimedia data by a profiling module in the central server, extracting one or more user preferences from the multimedia data and creating a profile for the user based on the extracted user preferences. The profiling module extracts one or more keywords from the multimedia data inputted by the user to define die one or more personalization parameters.

The method for creating user profile from a user selected multimedia data further comprises registering one or more service providers with the central server, accessing the profile of the user by the service providers, personalizing information based on the user preferences through a personalization engine in the central server, and delivering personalized information to the user.

The multimedia data inputted is one of a text, a still image, an audio, a video, an animation and interactivity content forms.

The method for creating user profile from a user selected multimedia data further comprises leveraging the multimedia input provided by the user to build the user profile by the personalization engine.

The personalization parameters comprise at least one of user preferences, behavior patterns, transactions and subjects.

The method for creating user profile from a user selected multimedia data further comprises accessing at least one service provider by the user, providing login credentials of the personalization engine, transmitting the user credentials to the personalization engine by the service provider, retrieving the user profile defined in the profiling module and providing personalized information to the user based on the user preferences stored in the personalization engine.

The various embodiments herein provide a system for creating user profile from a user selected multimedia data. The system comprises a mobile device for capturing a multimedia data, a client application pre-installed in the mobile device for capturing and uploading the captured data to a central server and a profiling module provided in the central server. The profiling module is adapted for processing the multimedia data, extracting one or more user preferences from the multimedia data, and creating a profile for the user based on the extracted user preferences.

The system further comprises a personalization engine provided in the central server for storing the uploaded multimedia data and plurality of service providers registered with the central server for providing the personalization information to one or more users.

The profiling module comprises one or more algorithms or software modules for decoding, analyzing, recognizing and generating one or more keywords associated with the input multimedia data to define the personalization parameters.

The client application connects to the central server through a communication network and provides a set of keywords generated to a central server. The communication network is any of a Bluetooth, Wi-Fi, WLAN, or the like compatible with the mobile device. The plurality of service providers is any one of a mobile service provider, a secure enterprise service provider, a web based service provider and a consumer service provider.

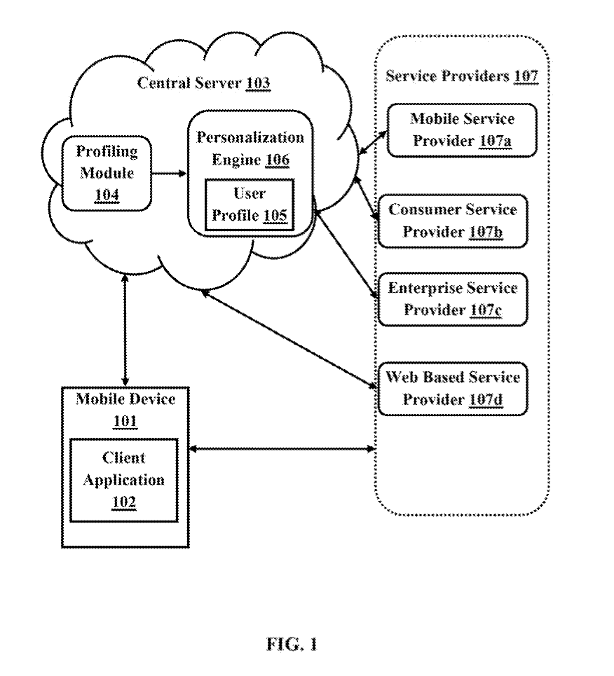

FIG. 1 is a block diagram illustrating a system for automatically creating a user profile from a user selected multimedia data, according to an embodiment of the present disclosure. A user is equipped with a mobile device 101. The mobile device 101 is at least one of a mobile phone, smart phone, tablet, phablet, laptop or any user device having at least one means to connect to internet. The mobile device includes a client application 102 pre-installed in the mobile device 101. Alternatively, the user downloads the client application 102 from the central server 103 and installs the client application 102 in the mobile device 101 runtime. The mobile device 101 is provided with various input means such as microphone, camera, Near Field Communication (NFC), and other similar means to capture a multimedia content. The user captures one or more multimedia content from the surroundings through the mobile device 101. The captured multimedia content comprises at least one of a video content, an audio file, images or so on which are stored in a memory of the mobile device 101. The memory also stores other multimedia contents received from various external sources over a communication network such as Multimedia Message Service (MMS), Short Message Service (SMS), Ringtones, recorded audio and video clips, text messages, etc. The user initiates the client application 102 and selects a preferred multimedia content from the memory. The user then uploads the plurality of multimedia content to a central server 103. The central server 103 comprises a profiling module 104 and a personalization engine 106. The profiling module 104 adopts a plurality of multimedia content processing mechanisms to extract relevant information/keywords from the uploaded multimedia content. The information herein refers to the user preferences. Further, the profiling module 104 automatically creates a profile 105 of the user based on the extracted information and stores the profile in the personalization engine 106 in the form of a relational graph. The central server 103 further allows a plurality of service providers 107 to register with the central server 103 for providing personalized services to the user. The plurality of service providers is any one of a mobile service provider 107a, secure enterprise service provider 107b, web based service provider 107c and a consumer service provider 107d. The service providers 107 access the user profile 105 for providing personalized service to the user based on the service selected by the user and the preferences set by the user. The service provider 107 uses a personalization engine 106 to access the user preferences and then provide specific and relevant services to the user.

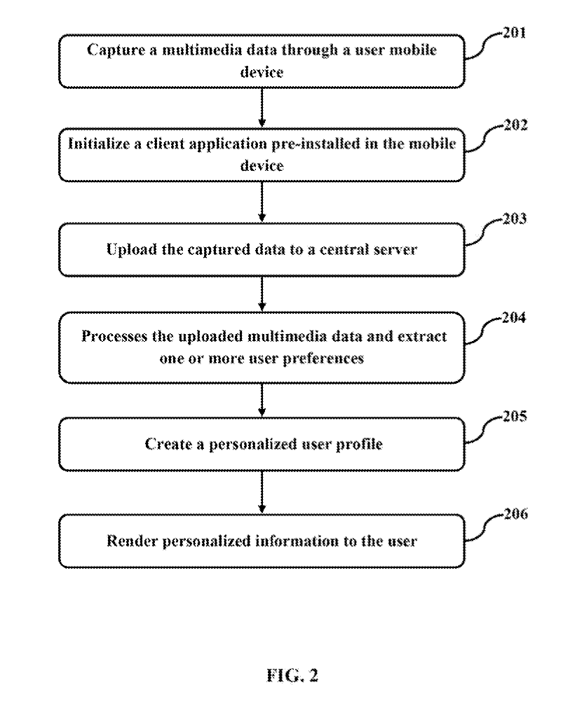

FIG. 2 is a flow diagram illustrating a method for creating a user profile from a user selected multimedia data, according to an embodiment of the present disclosure. The user captures a multimedia data through a user mobile device (201). The mobile device is equipped with one or more multimedia input capturing means such as camera, microphone, keypad, touch pad and the like and the multimedia data comprises audio, video, images, text, documents, interactive forms etc. The user initializes a client application pre-installed in the mobile device (202). The user then uploads the captured or pre-stored multimedia data to a central server (203). Alternately, the user first initializes the client application, captures the multimedia data and uploads the same in real time to the central server. The central server comprises a profiling module which processes the uploaded multimedia data by using one or more recognition mechanisms depending on the type of multimedia data received (204). The profiling module uses an image recognition mechanism for recognizing images, a video recognition mechanism for recognizing videos, an audio recognition mechanism for recognizing audio, a document recognizing mechanism for recognizing text and so on. The profiling module adopts a suitable recognizing mechanism, extracts user relevant information/preferences and stores in a personalization engine of the central server. The profiling module creates a user profile based on the extracted user preferences from the one or more multimedia data and stores the created user profile in the personalization engine (205). Based on the user profile, one or more service providers provide personalized relevant information/service to the users in a first request itself (206).

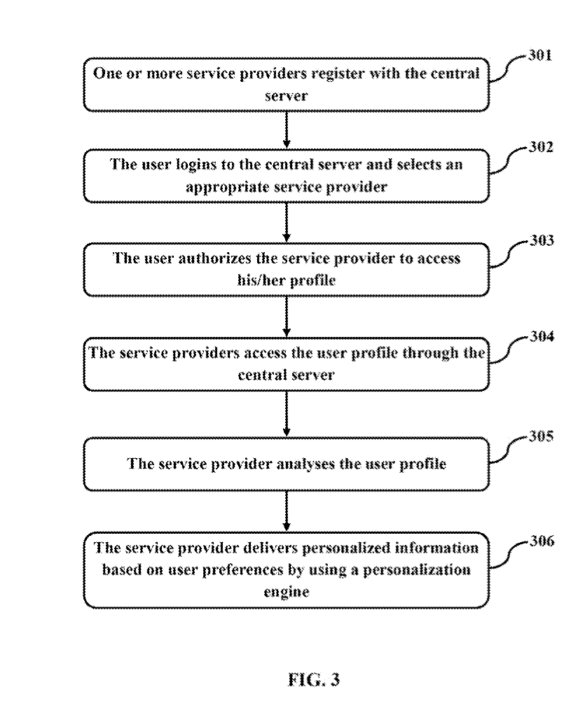

FIG. 3 is a flow diagram illustrating a method for providing personalized services to a user on accessing a service, according to an embodiment of the present disclosure. One or more service providers in various domains such as search, images, forums, ecommerce, tourism, advertising agencies or the like registers with the central server (301). The one or more service providers comprises but not limited to a mobile service provider, a consumer service provider, an enterprise service provider and a web based service provider. The user registered with the central server login with the unique login credentials, selects an appropriate service provider out of one or more service providers and accesses a preferred service offered by the selected service provider (302). If the selected service provider is registered with the central server, then the user provides the login credentials to the service provider and login tor the service. The user also authorizes the service provider to access his/her profile from the central server (303). The user selected service provider access the user profile stored in the central server through the personalization engine (304). The service provider retrieves the user profile from the central server and analyzes the user preferences (305). After analyzing the user profile, the service provider delivers personalized information to the user mobile device through a respective communication medium such as Wi-Fi, Bluetooth, GSM, CDMA, etc (306). The user receives all the relevant information pertaining to his/her interest while accessing the selected service provider's service in the first access itself.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification.

What is claimed is:

1. A method for creating a user profile from a user selected multimedia data, the method comprises;
capturing a multimedia data through a user mobile device;
initializing a client application pre-installed in the device;
uploading the captured multimedia data to a central server through the client application;
processing the multimedia data by a profiling module in the central server;
extracting one or more user preferences from the multimedia data; and
creating a profile for the user based on the extracted user preferences;
wherein the profiling module extracts one or more keywords from the multimedia data inputted by the user to define the one or more personalization parameters.

2. The method of claim 1, further comprises:
initializing a client application pre-installed in the mobile device;
capturing a multimedia data through a mobile device through the client application; and
uploading the captured multimedia data to a central server through the client application.

3. The method of claim 1, further comprises;
registering one or more service providers with the central server;
accessing the profile of the user by the service providers;
personalizing information based on the user preferences through a personalization engine in the central server; and
delivering personalized information to the user.

4. The method of claim 1, wherein the multimedia input is one of a text, a still image, an audio, a video, an animation and interactivity content forms.

5. The method of claim 1, further comprises leveraging the multimedia input provided by the user to build the user profile by the personalization engine.

6. The method of claim 1, wherein the personalization parameters comprises user preferences, behaviour patterns, transactions and subjects.

7. The method of claim 1, further comprises:
accessing at least one service provider by the user;
providing login credentials of the personalization engine;
transmitting the user credentials to the personalization engine by the service provider;
retrieving the user profile defined in the profiling module; and
providing personalized information to the user based on the user preferences stored in the personalization engine.

8. A system for creating user profile from a user selected multimedia data, the system comprising:
a mobile device for capturing a multimedia data;
a client application pre-installed in the mobile device for capturing and uploading the captured data to a central server;
a profiling module provided in the central server adapted for:
processing the multimedia data;
extracting one or more user preferences from the multimedia data; and
creating a profile for the user based on the extracted user preferences.

9. The system of claim 8, further comprising:
a personalization engine provided in the central server for storing the uploaded multimedia data; and
a plurality of service providers registered with the central server for providing the personalization information to one or more users.

10. The system of claim 8, wherein the profiling module comprises one or more algorithms or software modules for decoding, analyzing, recognizing and generating one or more keywords associated with the input multimedia data to define the personalization parameters.

11. The system of claim 8, wherein the client application connects to the central server through a communication network and provides a set of extracted keywords to a central server.

12. The system of claim 8, wherein the communication network is any of a Bluetooth, Wi-Fi, WLAN, etc compatible with the mobile device.

13. The system of claim 8, wherein the plurality of service providers is any one of a mobile service provider, secure enterprise service provider, web based service provider and consumer service provider.
